(19) United States
(12) Patent Application Publication
(10) Pub. No.: US 2014/0130710 A1
(43) Pub. Date: May 15, 2014

(54) HYDROPHOBIC COATING AND A METHOD FOR PRODUCING HYDROPHOBIC SURFACE

(71) Applicants: Henrikki Mertaniemi, (US); Olli Ikkala, Helsinki (FI); Jan-Erik Teirfolk, Turku (FI); Antti Laukkanen, Helsinki (FI); Robin Ras, Espoo (FI)

(72) Inventors: Antti Laukkanen, Helsinki (FI); Jan-Erik Teirfolk, Turku (FI); Olli Ikkala, Helsinki (FI); Robin Ras, Espoo (FI); Henrikki Mertaniemi, Espoo (FI)

(73) Assignee: UPM-KYMMENE CORPORATION, Helsinki (FI)

(21) Appl. No.: 14/115,159

(22) PCT Filed: May 4, 2012
(86) PCT No.: PCT/FI2012/050435

§ 371 Date: Jan. 29, 2014

(30) Foreign Application Priority Data
May 6, 2011 (FI) 20115435

(51) Int. Cl. C09D 101/02; B05D 1/00; B05D 5/00

(52) U.S. Cl. CPC C09D 101/02; B05D 5/00; B05D 1/60
USPC 106/203.3; 427/203; 427/202; 427/255.28; 427/458; 427/201; 536/56; 106/203.1; 106/163.01

(57) ABSTRACT

A method for producing a superhydrophobic surface, which includes cellulosic material. The cellulosic material includes nanocellulose particles and the method includes adding the nanocellulose particles to a surface and hydrophobizing the nanocellulose particles with a modifier before, during and/or after the addition of the particles. The invention further relates to a hydrophobic coating.

### FIELD OF THE INVENTION

The invention relates to a method for producing hydrophobic surfaces. The invention further relates to a hydrophobic coating.

### BACKGROUND OF THE INVENTION

Superhydrophobic surfaces and super water repellent surfaces are names for surfaces that have extremely high repellency or extremely low affinity for water. Hydrophobicity of a material is determined by the contact angle of a water droplet on the surface. Generally superhydrophobic surface is understood as a surface that has a water droplet contact angle higher than 140°, more preferably higher than 150° (and tilt angle preferably smaller than 5°). To achieve this phenomenon, a surface should have a special hierarchal surface roughness and certain level of hydrophobicity.

Classic examples of superhydrophobic surfaces are leaves of a lotus plant, which are famous for their self-cleaning properties—all dirt is carried away by water drops rolling off the surface. Even after emerging from mud, the leaves do not retain dirt when they unfold. The self-cleaning effect is caused by the hierarchal roughness and hydrophobic waxes on the surface, making the surface superhydrophobic (contact angle>140°). Water drops on a lotus leaf have a very high contact angle (about 160°) and they slide off the surface easily at tilt angles smaller than 5°.

On an inclined superhydrophobic surface a droplet does not slide off; it rolls off. When the droplet rolls over a contamination, the particle is removed from the surface if the force of absorption of the particle is higher than the static friction force between the particle and the surface. Usually the force needed to remove a particle is very low due to the minimized contact area between the particle and the surface. As a result, the droplet cleans the leaf by rolling off the surface.

As self cleaning of superhydrophobic microscopic to nanoscopic surfaces is based on a purely physio-chemical effect, it can be transferred onto technical surfaces on biomimetic basis. The first and the most successful product with superhydrophobic self-cleaning properties was the facade paint Lotusan launched in 1999, and it has been applied on more than 500,000 buildings worldwide so far. In literature, researchers have developed treatments, coatings, paints, roof tiles, fabrics and other surfaces that can stay dry and clean themselves in the same way as the lotus leaf. This can usually be achieved using special fluorochemical or silicone treatments on structured surfaces or with compositions containing micro-scale particulates.

In addition to self-cleaning behavior, superhydrophobic surfaces are suggested to be used to reduce the rain fade and build-up of ice and snow in various constructions in cold environment, for example in microwave antennas and high-voltage transmission lines. However, in many technologies hazardous compounds are used to obtain the needed hydrophobicity and, moreover, expensive techniques are used to obtain the needed hierarchal surface roughness. There is, therefore, still a need for a new solution for producing superhydrophobic surfaces.

### SUMMARY OF THE INVENTION

This invention discloses a novel and inventive method for producing superhydrophobic surfaces. In addition, this invention discloses a novel and inventive superhydrophobic coating material.

It was surprisingly found by the inventors of the present invention that cellulose nanofibers, for example spray-dried cellulose nanofibers, may form particles that have substantially similar size and topography as papillose cells on the surface of a lotus leaf and, thus, are able to enable the preparation of superhydrophobic surfaces. For example, an addition of hydrophobized spray-dried nanocellulose particles to a surface was found to increase the contact angles and make water drops slide off at smaller tilt angles. Therefore, due to the present invention, it is possible to produce cellulose based superhydrophobic surfaces. However, due to very hydrophilic nature of cellulose molecules, hydrophobisation is needed for the effect of the nanocellulose particles on the surface. Hence, used nanocellulose microparticles are hydrophobized with a modifier either before or after the deposition.

The present invention discloses a coating in which the particles have a unique surface structure that is needed to achieve superhydrophobicity. The structure generates hierarchal surface roughness when applied on a surface. Simple drying of nanofibrils from hydrogel dispersion leads to too dense a film. In the structure according to the present invention, the particles are loosely packed so that there can remain air trapped within the formed particle. Air is also trapped between the particles when they are applied on a surface. The trapped air in the coating, i.e. the nano-to-micro porous assembly of nanocellulose, is an important requirement for the needed properties. This invention discloses advantageous embodiments to produce the needed structure comprising a coating of loosely packed cellulose nanofibrils.

Nanocellulose particles used in the present invention have a high surface area due to the nano- to microscopic surface morphology. Advantageously, the surface area of the nanocellulose particles in the coating is at least 60 m²/g or at least 65 m²/g calculated by BET method, more preferably the surface area is at least 70 m²/g or at least 75 m²/g calculated by BET method. In an example, the surface area is 200 m²/g at the most calculated by BET method.

Adding chemically modified nanocellulose particles, for example spray-dried nanocellulose particles, to a surface changes its wettability, increasing the advancing contact angle so that it is larger than 140°, typically larger than 150°. In addition, the contact angle hysteresis decreases, allowing drops to slide off the surface already at smaller tilt angles.

According to an example embodiment of the invention, the amount of the superhydrophobic coating on a surface is 6 g/m² at the most, more preferably 5 g/m² at the most, and most preferably 4 g/m² at the most.

According to an advantageous embodiment of the invention, modifications known to an average person skilled in the art of paper and board manufacturing, such as AKD or ASA or rosin size chemistry, are used for hydrophobisation of spray-dried nanocellulose particles. Alternatively, fluorosilane compounds, preferably 1H,1H,2H,2H-perfluorooctyltriethoxysilane, and/or (tridecafluoro-1,1,2,2-tetrahydrooctyl) trichlorosilane, are used as modifiers.

The method according to an example embodiment of the present invention leads to very high contact angles and, in addition, to low tilt angles, i.e. the surfaces are superhydrophobic. Therefore, the coated surfaces disclosed in the present invention are extremely water repellent. They may also show self-cleaning properties. The product produced according to the present invention is advantageously used, for example, for surfaces (specially for self-cleaning and dirt-repellent surfaces or non-freezing surfaces), filters, membranes, in packaging materials, and, generally, for coating and paint industry, where superhydrophobicity is recognized as an important phenomenon.

Advantageously, the coated surfaces disclosed in the present invention prevent the accumulation of ice on coated metal surfaces in sub-zero environment, for example in aluminum high-voltage transmission lines and support towers or any metallic constructions in arctic environment. Currently, support towers and conductors must be reinforced to withstand the increased weight associated with ice buildup. Reducing of ice accumulation on conductors may decrease the construction costs and need for maintenance, and increase the longevity and reliability of power transmission systems.

The coating comprising nanocellulose particles is preferably a thin, optically transparent or opaque film.

Advantageously, the method according to the present invention for producing superhydrophobic surface comprises
adding the nanocellulose particles to a surface; and
hydrophobizing the nanocellulose particles with a modifier before, during and/or after the addition of the particles.

Advantageously, the coating comprises spray-dried nanocellulose particles.

Alternatively or in addition, the coating comprises, for example, refined nanocellulose aerogel particles.

In an example, the hydrophobisation step of the nanocellulose particles is realized by chemical vapour deposition. Alternatively, the modifier used is preferably in liquid form.

In an example, the method comprises
mixing dry hydrophobized nanocellulose particles with thermoset or thermoplastic coating powder, and
adding the mixture of the nanocellulose particles and the coating power to the surface.
   or
coating the surface with charged thermoset or thermoplastic coating powder,
coating the surface with nanocellulose particles, and
curing the coated surface.

Advantageously, the nanocellulose particles in the coating have a medium particle size between 500 nm and 50 μm, or between 800 nm and 40 μm, more preferably between 1 μm and 30 μm or between 3 μm and 20 μm, and most preferably between 5 μm and 13 microns.

Advantageously, a water drop displays a defined contact angle on the above mentioned superhydrophobic surface, the contact angle being at least 140°, preferably at least 150°, more preferably at least 160°, and most preferably at least 170°.

The method according to an example embodiment of the invention comprises the following steps to obtain a hydrophobic surface:
making nanocellulose particles,
adding nanocellulose particles to a surface; and
hydrophobizing the nanocellulose particles with a modifier before and/or after the addition.

In an example, the coating comprises nanocellulose particles that are produced from dilute nanocellulose hydrogel in the following process, wherein
the water is first removed from nanocellulose hydrogel by solvent extraction, and
the dry nanocellulose material is grinded to suitable powder size.

Aspects of the invention are characterized by what is stated in the independent claims 1, 14, 23 and 24. Various embodiments of the invention are disclosed in the dependent claims.

### DESCRIPTION OF THE DRAWINGS

In the following, the invention will be illustrated by drawings in which

FIGS. 1a-1c show example embodiments of the present invention,

FIGS. 2-3 show biomimicracy of spray-dried nanocellulose particles (FIGS. 3) compared with a lotus leaf (FIGS. 2), wherein FIGS. 2a-2b show micro- and nanostructures of the lotus leaf, FIGS. 3a-3b show micro- and nanostructures of the spray-dried nanocellulose particles, and FIGS. 3c and 3d show a high magnification SEM image on a surface with scale bars of 100 nm,

FIG. 4 shows a comparison of the surface structures of the lotus leaf (large picture) and spray-dried nanocellulose particles (inset),

FIGS. 5a-5c show spray-dried cellulose nanofibers on a filter paper,

FIGS. 6a-6b show pictures of superhydrophobic surfaces produced according to an example embodiment of the present invention, and

FIG. 7 shows liquid marbles produced from superhydrophobic nanocellulose particles.

### DETAILED DESCRIPTION OF THE INVENTION

In this application the term “CA” refers to a contact angle. The contact angle is the angle at which the liquid interface meets the solid interface. When a drop of a liquid rests upon a surface, it will spread out over the surface to a degree based upon such factors as the surface tension of the liquid and the substrate, the roughness of the surface, etc. The quantification of hydrophobicity can be expressed as the degree of contact angle of the drop of the liquid on the surface. Those skilled in the art are familiar with various means to measure the contact angle of liquid on surfaces, such as an optical contact angle meter.

The term “modifier” refers to a compound used for a hydrophobisation of nanocellulose particles.

The term “spray-drying” refers to a method of producing a dry powder by rapidly drying a liquid or slurry with hot gas, and the term “spray-dried” refers to a powder that is dried using the spray-drying-method. The term SCP refers to spray-dried cellulose particles.

The term superhydrophobicity refers to a characteristic of a material that is extremely water-repellent having high water contact angle, i.e. CA is typically at least 140°, more preferably at least 150° and most preferably at least 160°.

Advantageously both, advancing (maximal) contact angle and receding (minimal) contact angle, are at least 140°, more preferably at least 150° and most preferably at least 160°. The difference between the advancing contact angle and the receding contact angle is preferably as small as possible, i.e. the contact angle hysteresis is preferably very small, for example less than 10°. Advantageously, the tilting angle of the material is very small, preferably less than 10°, more preferably less than 7° and most preferably less than 5°.

The term “CVD” refers to chemical vapour deposition, the term FTES refers to 1H,1H,2H,2H-perfluorooctyltriethoxysilane, the term AKD refers to alkylketene dimer, the term ASA refers to alkenyl succinic anhydride and the term FTCS refers to (tridecafluoro-1,1,2,2-tetrahydrooctyl) trichlorosilane.

The term “nanocellulose” refers to a collection of isolated cellulose microfibrils or microfibril bundles derived from cellulose raw material. Microfibrils have typically high aspect ratio: the length might exceed two, five or ten micrometers while the number-average diameter is typically below 200 nm. The diameter of microfibril bundles can also be larger but generally less than 1 μm. The smallest microfibrils are similar to the so called elementary fibrils, which are typically 2-12 nm in diameter. The dimensions of the fibrils or fibril bundles are dependent on the raw material and a disintegration method. The nanofibrillated cellulose may also contain some hemicelluloses; the amount may be dependent on the plant source.

In this application, the term “nanocellulose particles” refers to a discrete physical entity formed of several nanocellulose microfibrils. Therefore, each nanocellulose particle typically comprises several (tens, hundreds, even thousands) nanocellulose microfibrils. Advantageously, the nanocellulose particles in the coating have a medium particle size between 500 nm and 50 μm, or between 800 nm and 40 μm, more preferably between 1 μm and 30 μm or between 3 μm and 20 μm, and most preferably between 5 μm and 15 microns.

There are several widely used synonyms for nanocellulose. For example: nanofibrillated cellulose (NFC), microfibrillar cellulose, nanofibrillar cellulose, cellulose nanofiber, nano-scale fibrillated cellulose, microfibrillated cellulose (MFC), or cellulose microfibrils.

The nanocellulose used in this invention can come from any plant material that contains cellulose, for example wood material. The wood material can come from softwood trees, such as spruce, pine, fir, larch, douglas-fir or hemlock, or from hardwood trees, such as birch, aspen, poplar, alder, eucalyptus or acacia, or from a mixture of softwood and hardwood. Non-wood material can come from agricultural residues, grasses or other plant substances such as straw, leaves, bark, seeds, hulls, flowers, vegetables or fruits from cotton, corn, wheat, oat, rye, barley, rice, flax, hemp, manila hemp, sisal hemp, jute, ramie, kenaf, bagasse, bamboo or reed.

According to an advantageous embodiment of the present invention, a superhydrophobic surface is produced from cellulose based material by adding nanocellulose on the surface. Nanocellulose may be spray-dried nanocellulose, refined nanocellulose aerogel, dried and refined dilute nanocellulose hydrogel or another kind of nanocellulose type. According to an advantageous embodiment, the nanocellulose is spray-dried nanocellulose.

There are two factors required for obtaining a superhydrophobic surface. First, the surface must have a hierarchal roughness. Second, the surface must have a hydrophobic surface chemistry. The nanocellulose particles can be reacted with the modifier by bringing the modifier in contact with the nanocellulose particles. Surprisingly the nanocellulose particles used according to the present invention have been found to provide the needed surface morphology on a surface, i.e. a thin layer of air forms when the surface produced according to the present invention is immersed in water. In addition, the surface is typically gas-permeable.

The method for producing a superhydrophobic surface always comprises the hydrophobisation of spray-dried nanocellulose particles. Using nanocellulose particles together with a modifier, it is possible to produce surfaces having contact angles larger than 140°, preferably larger than 150° wherein the water drops slide off at small or moderate tilt angles.

According to an example embodiment of the invention, the unique surface roughness and particle size of spray-dried nanocellulose particles are used for the required hierarchal roughness.

According to an example embodiment of the invention, a distance between adjacent nanocellulose particles on the surface of the coating is at most 20 μm or at most 15 μm. According to another example embodiment of the invention, a distance between adjacent nanocellulose particles on the surface of the coating is at most 10 μm.

According to another example embodiment of the invention, the nanocellulose particles used for the coating particles are produced from dilute nanocellulose hydrogel in the following process:
The water is first removed from nanocellulose hydrogel by solvent extraction. The nanocellulose material shows high porosity after the residual solvent is removed.
The dry nanocellulose material is grinded to suitable powder size.

According to another example embodiment, a refined nanocellulose aerogel is used as a raw material for the coating. This example embodiment preferably comprises the following steps:
The water is first removed from nanocellulose hydrogel by freeze drying or supercritical drying. The nanocellulose material shows high porosity after the water is removed.
The dry nanocellulose material is grinded to suitable powder size.

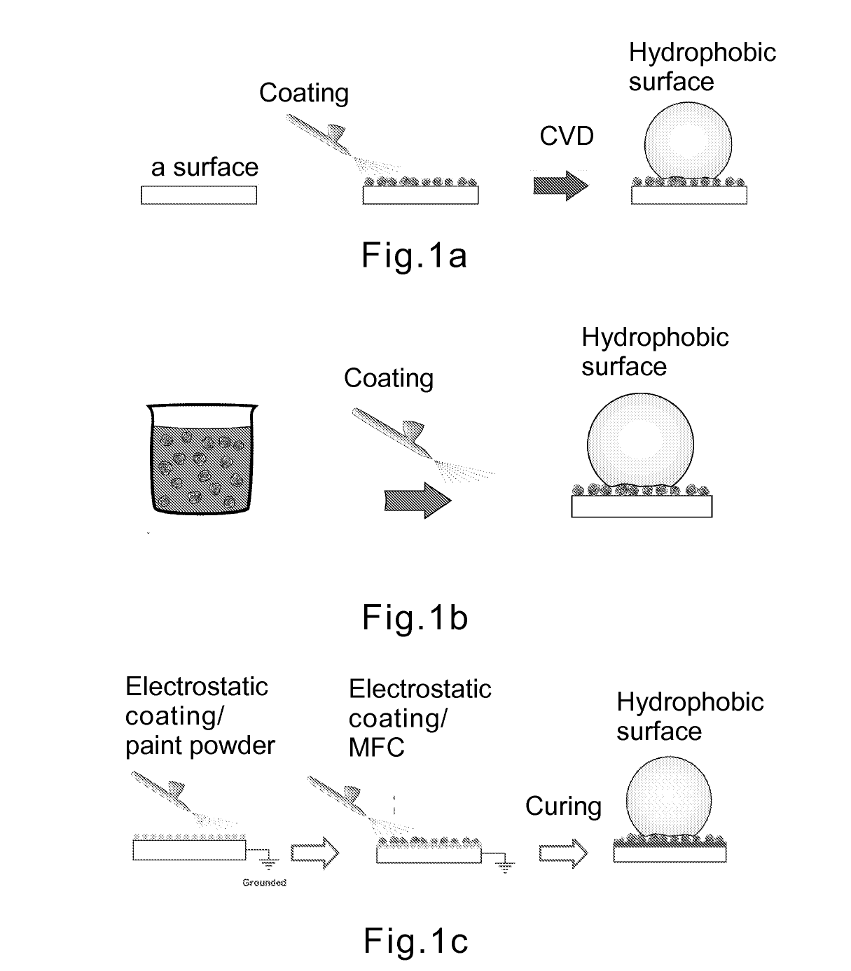

FIG. 1a presents an example embodiment of the invention. In FIG. 1a, the nanocellulose particles are first applied to a surface after which the surface is coated for needed hydrophobization. This can be done, for example, by chemical vapour deposition that does not require solvents. According to an example embodiment of the invention, the hydrophobisation step is realized by chemical vapour deposition of FTCS or FTES on a particle coated surface, but other hydrophozing chemicals can also be used.

It is also possible to use solvents in the method, i.e. the modifier may be in liquid form. FIG. 1b presents an example embodiment of the invention wherein the nanocellulose particles are hydrophobised before they are applied to a surface. This can be done by attaching molecules, for example FTCS molecules or FTES molecules, covalently on nanocellulose particles before applying the nanocellulose particles on a surface. This can be done, for example, by using toluene dispersion. Some other hydrophozing chemicals can also be used instead of said FTCS molecules or FTES molecules.

According to an advantageous embodiment of the present invention, hydrophobization of nanocellulose particles is implemented using a fluorinated silane compound. Not only the above mentioned silane compounds but some other silane compounds can also be used for hydrophobization of nanocellulose particles. Advantageously, the silane compound comprises, for example,
fluorosilanes,
trichloromethylsilane (TCMS),
trichloroethylsilane,
trichloro(n-probyl)silane,
trimethoxymethylsilane,
triethoxymethylsilane,
(3-phenylpropyl)methyldichlorosilane (PMDS),
benzyltrichlorolane,
methylbenzyl-trichlorosilane,
trifluoromethylbenzyltrichlorosilane,
methyltriethoxysilane,
(3-phenylpropyl)methyldimethoxysilane,
(3-phenylpropyl)methyldiethoxysilane,
Tris(trimethylsiloxy)chlorosilane (Tris-TMSCI),
Tris(trimethylsiloxy)silylethyldimethylchlorosilane, and/or
Bis(trimethylsiloxy)methylsilylethyldimethylchlorosilane.

According to an advantageous embodiment, the compound used for hydrophobization of nanocellulose particles, i.e. the modifier, is selected from a group of compounds known to an average person skilled in the art of paper and board manufacturing as hydrophobic sizing agents. Advantageously the modifier comprises alkyl ketene dimer compounds (AKD), alkenyl succinic anhydride compounds (ASA) and/or rosin sizes.

FIG. 1c presents an advantageous embodiment of the invention, wherein a powder coating process is used to apply nanocellulose particles to a surface. The process is based on electrostatic deposition of charged paint powders on grounded surface, followed by curing. The coating powder may be based on thermosets or thermoplastics. The thermosetting variety incorporates a cross-linker into the formulation. When the powder is baked, it reacts with other chemical groups in the powder to polymerize, improving the performance properties. The thermoplastic variety does not undergo any additional reactions during the baking process, but rather only flows out into the final coating. Most preferably, the used polymer comprises at least one of the following polymers: polyester, polyurethane, polyester-epoxy (known as hybrid), straight epoxy (fusion bonded epoxy) and acrylics. The particle size of the coating powder is preferably between 5 to 50 microns, more preferably between 6 and 20 microns and most preferably between 7 and 12 microns. Superhydrophobic surfaces produced according to the invention can be prepared from nanocellulose particles using the powder coating process.

As can be seen in FIG. 1c, the surface can first be coated with paint powder using an electrostatic powder coating process. At the second stage, nanocellulose particles are brought on top of the paint powder. The nanocellulose particles are partially encapsulated into paint while the paint powder is cured at elevated temperature. In the following two possible approaches are described.

In the first approach (FIG. 1c), the grounded surface is coated with charged coating powder at the first stage. At the second stage, the surface is covered with the hydrophobized nanocellulose particles followed by curing. Curing of the paint powder binds the nanocellulose particles on the surface. After the curing, the surface is superhydrophobic. Thus, in an example, the method according to the present invention comprises:
coating the surface with charged thermoset or thermoplastic coating powder,
coating the surface with the nanocellulose particles, and
curing the coated surface.

In the second approach, dry hydrophobized nanocellulose particles are first mixed with the coating powder prior to the coating stage. The hydrophobized nanocellulose particles can be mixed with coating powder ingredients also prior to the production of the coating powder. The powder mixture is then charged and deposited on a grounded surface. After the electrostatic deposition, the nanocellulose particles cover the target surface with the paint powder. Curing of the paint powder binds the nanocellulose particles on the surface. After the curing, the surface is superhydrophobic. Altering the ratio between the hydrophobized nanocellulose particles and paint powder, relative hydrophobicity of the surface can be adjusted.

According to an example embodiment of the invention, the amount of the used modifier is at least 1% of the (oven dry) weight of the used nanocellulose particles. According to another example, the amount of the used modifier is at least 2% of the (oven dry) weight of the used nanocellulose particles.

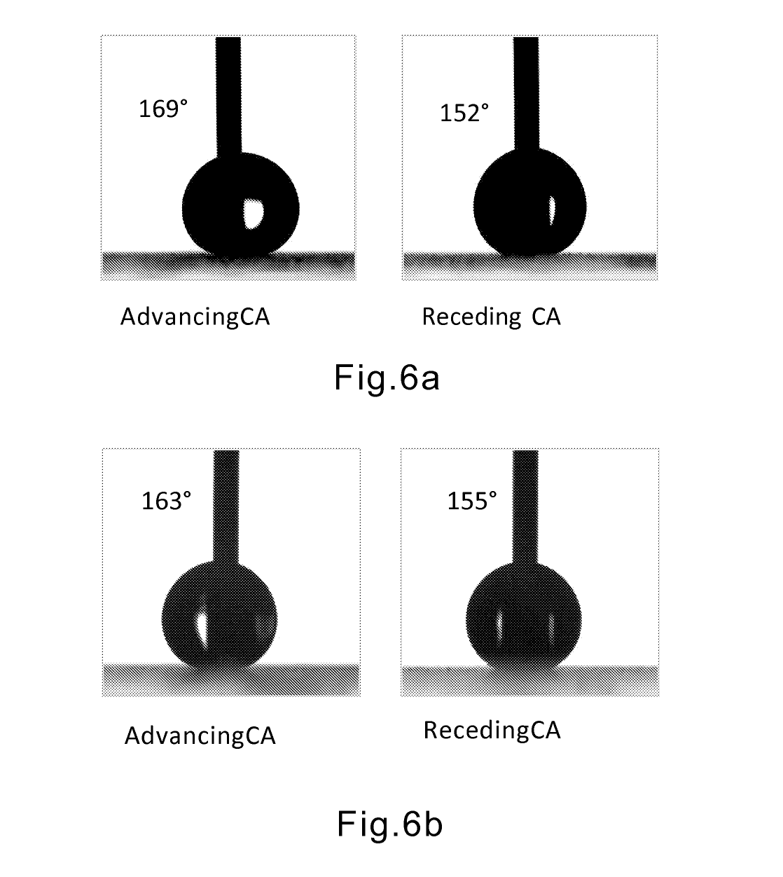

According to an example embodiment of the invention, the nanocellulose coating produced according to an example embodiment of the present invention is used to produce so called “liquid marbles”. According to this embodiment, the superhydrophobic cellulose particles are used for making liquid marbles, where a liquid drop is entirely covered by a layer of hydrophobic particles, as shown in FIG. 7. When a liquid marble is deposited on a solid substrate, the encapsulated liquid is not in contact with the substrate. Thus, the liquid marble is able to move easily on the substrate if a small force is applied. Furthermore, no liquid residues are left on the substrate. This enables precisely targeted, non-contaminating transport of small quantities of liquids, which may be useful for microfluidic lab-on-a-chip applications where miniature systems allow high-throughput analysis and purifications. Liquid marbles may also be used as miniature reactors in applications where small liquid volumes are beneficial. Furthermore, since the porous encapsulating layer allows gases to permeate, liquid marbles can be filled with indicator solutions, and thus be used as gas sensors. In addition, by drying liquid marbles, hollow spheres can be created that have possible applications in pharmaceutics.

### EXAMPLE

### Structure of a surface with spray-dried nanocellulose compared with a lotus leaf

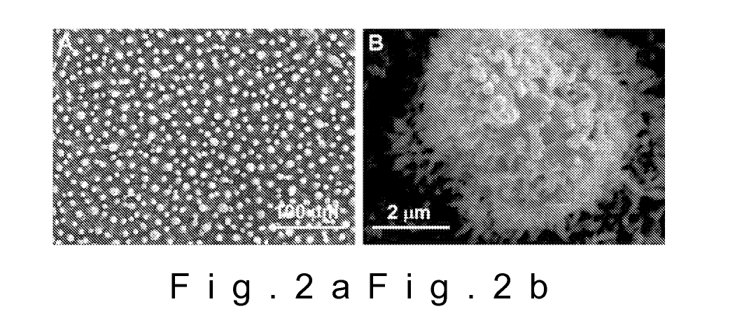

FIGS. 2a and 2b (Sun et al. in Acc. Chem. Res. 2005, 38, 644-652) show micro- and nanostructures on a lotus leaf (Nelumbo nucifera). FIG. 2a shows a large-scale SEM image of the lotus leaf. Each epidermal cell forms a papilla and has a dense layer of epicuticular waxes superimposed on it. FIG. 2b shows a magnified image on a single papilla presented in FIG. 2a.

FIGS. 3a and 3b show micro- and nanostructures on the spray-dried nanocellulose particles. FIG. 3a shows large-scale SEM image of the particles on a SEM graphite tape. The size distribution is approximately 5-15 μm. FIG. 3b shows a magnified image of a single particle. The particle has the morphology of a shrunken sphere with a nanofibrous surface character. FIGS. 3c and 3d show high magnification SEM image on a surface with scale bars of 100 nm.

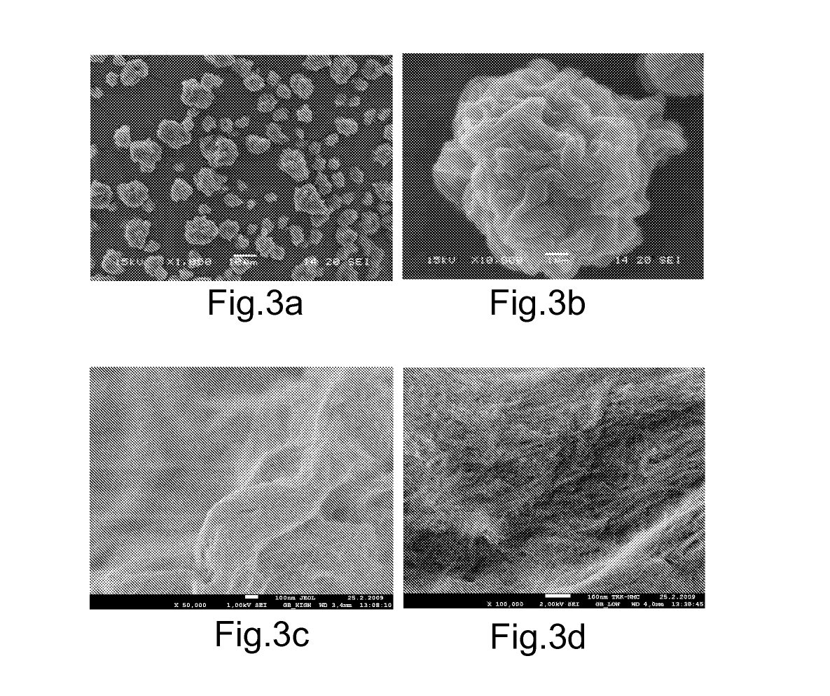

FIG. 4 shows a comparison of the surface structures of the lotus leaf (large picture) and spray-dried NFC particles (inset).

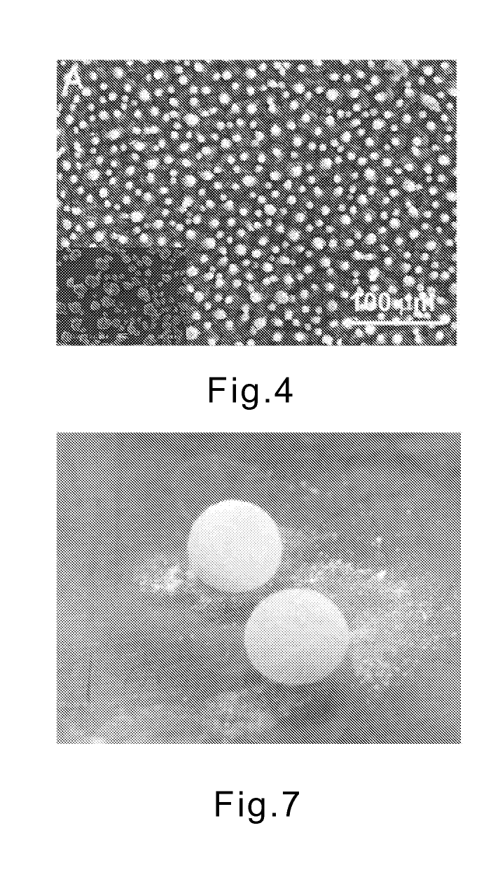

FIGS. 5a-5c show spray-dried cellulose nanofibers on a filter paper. Scale bars 10 μm, 2 μm and 100 nm. The density of cellulose particles on the filter paper surface is close to the density of the papillae of the lotus leaf. Due to the roughness of the filter paper, there are cellulose particles also at a lower level between the large fibers of the paper. All the lotus papillae (FIGS. 2a and 2b) are on the same level, because the underlying cell layer is quite smooth at the scale of hundreds of microns.

The lotus leaf has papillose epidermal cells and epicuticular wax tubules cover the surface. Cellulose particles are about the same size and have micron-scale roughness, like the lotus leaf.

### Experimental Tests

Experimental tests were carried out. In the following examples it is demonstrated how the special surface structure of spray dried nanocellulose can be utilized to achieve superhydrophobic surfaces. Also surfaces that have advancing contact angles larger than 150° were prepared using the spray-dried cellulose nanofibers.

One approach (FIG. 1a) for making the SCPs hydrophobic was to use chemical vapor deposition (CVD) after applying SCPs to a substrate. Another approach (FIG. 1b) was to let the SCPs particles react with a fluorinated silane in toluene before applying them to a substrate.

### Sample Preparation

For sample preparation, glass slides were first cleaned using water with a detergent and finally rinsed with ethanol.

1a. The First Approach

One approach (presented in FIG. 1a) for making the SCPs hydrophobic was to use chemical vapor deposition (CVD) after applying SCPs to a substrate. In the first approach, a 1% w/w dispersion of SCPs in ethanol was sprayed to a glass surface with an airbrush, resulting in a visible layer. Subsequently, samples were dried in ambient conditions. Finally, the samples were coated with (tridecafluoro-1,1,2,2-tetrahydrooctyl)trichlorosilane (FOTS) via CVD at 90° C. for 8 hours. A glass slide without any spray-dried cellulose was also coated for a reference. FOTS was supplied by ABCR (Germany) and used as received.

1b. The Second Approach

The second approach (presented in FIG. 1b) was to let the SCPs particles react with a fluorinated silane in toluene before applying them to a substrate. In the second approach, SCPs reacted first with FOTS in dry toluene for 3 hours. Subsequently, the particles were washed with toluene to remove FOTS not reacted. Finally, the solvent was changed to ethanol. A layer of 1% w/w dispersion was sprayed to a glass surface using an airbrush, and the sample was subsequently dried in atmospheric conditions.

### 2. Measurement Procedures

Contact angles (CA) were measured using a KSV Instruments CAM 200 optical contact angle measuring device with a software-controlled dispenser. A 25-gauge flat-tipped needle and water purified with a Milli-Q device were used. KSV bundled software was used to fit Young-Laplace curves to images.

To determine CAs, a drop of about 2 μl was first applied to a surface using the needle of the dispenser. Subsequently, the needle was lowered so that the tip was near the surface at the back edge of the drop. This way the needle did not disturb the shape of the drop in pictures remarkably, and curve fitting could be performed successfully.

To measure the advancing CA, water was added to the drop at the speed of 0.4 μl/s, and pictures were taken with 500 ms intervals. After measuring the advancing CA, more water was added at a higher speed to reduce the measuring time. Subsequently, for measuring the receding CA, water was withdrawn at about 1.2 μl/s and pictures were taken with 500 ms intervals. A Young-Laplace curve was fitted to each picture, and the CA value for a 6.0 μl drop was linearly interpolated using the data range where the width of the drop at the contact line increased at a constant velocity. Usually these volumes ranged from 3 to 10 μl. Drops larger than 10 μl were not used in calculations, since they deformed significantly by gravity. When determining the advancing CA, the larger of the two contact angles (left and right) was chosen, since the side with the larger CA was found to advance more likely. Conversely, when determining the receding CA, the smaller of the two angles was used for calculations. The error estimate given with the CA values is the standard error of the linear regression.

Scanning Electron Microscopy (SEM) was performed using a JEOL JSM7500FA field emission microscope. Before imaging, a 5-nm layer of Au—Pd was sputtered to the surface.

### 3. Results

SEM examination revealed that at several length scales, surfaces coated with spray-dried cellulose have topographical features similar to those of lotus leaves. First, SCPs are about the same size as papillose cells on a lotus leaf. In addition, SCPs have rather similar distribution on the surface than papillose cells on a lotus leaf. It can be seen that SCPs coated with FOTS aggregate less and form a more uniform, lotus-like layer than pure SCPs. Second, SCPs have micron-scale roughness similar to the lotus surface. Finally, the surface of SCPs has fibers with width of 10-100 nm, which are approximately of the same size than wax tubules on lotus leaves. Unlike the wax tubules, however, the majority of the cellulose fibers do not stick out from the surface, but rather lie parallel to the surface. Some fraction of the cellulose nanofibers may stick out from the surface.

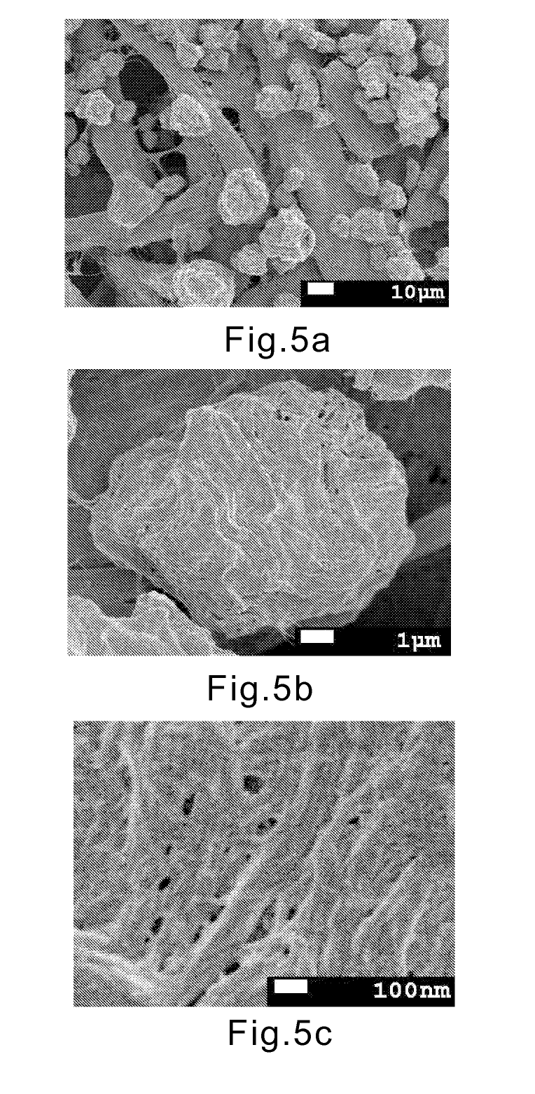

Adding SCPs to a surface was found to considerably increase the contact angle and make surfaces superhydrophobic, enabling drops to easily slide off the surface at small tilt angles. Using the first approach, which included CVD, a surface was prepared that has advancing and receding CAs of 169±4° and 152±4°, respectively, as illustrated in FIG. 6a. The reference sample without SCPs was found to have a static equilibrium CA smaller than 120°.

Water drops applied to the horizontal surface with SCPs were observed to slide off readily when the surface was tilted a few degrees.

Using the second approach, which consists of first making the particles hydrophobic, and subsequently spraying them to a substrate, a surface was prepared that has advancing and receding CAs of 163±3° and 155±3°, respectively. The contact angles are illustrated in FIG. 1b. Water drops were observed to slide off this surface as well at small tilt angles of a few degrees.

Superhydrophobized NFC particles have a broad application range, for example as a novel functional additive for paint and coating industry. In addition, super hydrophobized NFC particles can be used in existing products, for example as a surface treatment for various ply-wood products where water-repellence or self-cleaning properties are desirable.

One skilled in the art readily understands that the different embodiments of the invention may have applications in environments where optimization of a nanofibrillated cellulose pulp fibrillation is desired. Therefore, it is obvious that the present invention is not limited solely to the above-presented embodiments, but it can be modified within the scope of the appended claims.

1. A method for producing a superhydrophobic surface, which comprises cellulosic material, wherein
the cellulosic material comprises nanocellulose particles and the method comprises:
adding the nanocellulose particles to a surface; and
hydrophobizing the nanocellulose particles with a modifier before, during and/or after the addition of the particles.

2. The method according to claim 1, wherein a surface area of the nanocellulose particles is at least 60 m²/g.

3. The method according to claim 1, wherein a water drop on the superhydrophobic surface displays a defined contact angle of at least 150°.

4. The method according to claim 1, wherein the superhydrophobic surface comprises nanocellulose particles having particle size between 5 to 50 microns.

5. The method according to claim 1, wherein the superhydrophobic surface comprises nanocellulose particles that are produced from dilute nanocellulose hydrogel in the following process, wherein
the water is first removed from nanocellulose hydrogel by solvent extraction, and
the dry nanocellulose material is grinded to suitable powder size.

6. The method according to claim 1, wherein the superhydrophobic surface comprises spray-dried nanocellulose particles.

7. The method according to claim 1, wherein the superhydrophobic surface comprises refined nanocellulose aerogel particles.

8. The method according to claim 1, wherein the hydrophobisation step is realized by chemical vapour deposition.

9. The method according to claim 1, wherein the modifier is in liquid form.

10. The method according to claim 1, wherein the modifier is selected from the following group:
AKD (alkyl ketene dimer),
ASA (alkenyl succinic anhydride), and
rosin size.

11. The method according to claim 1, wherein the modifier fluorosilan.

12. The method according to claim 1, wherein the method comprises
coating the surface with charged thermoset or thermoplastic coating powder,
coating the surface with the nanocellulose particles, and
curing the coated surface.

13. The method according to claim 1, wherein the method comprises
mixing dry hydrophobized nanocellulose particles with thermoset or thermoplastic coating powder,
adding the mixture of the nanocellulose particles and the coating power to the surface.

14. Superhydrophobic coating, which surface comprises cellulosic material, wherein
the superhydrophobic surface comprises hydrophobised nanocellulose particles, and
the surface area of used nanocellulose particles is at least 60 m²/g.

15. The superhydrophobic coating according to claim 14, wherein a water drop on the coating displays a defined contact angle of at least 150°.

16. The superhydrophobic coating according to claim 14, wherein the nanocellulose is hydrophobised by using at least one modifier, and the at least one modifier is selected from the following group:
AKD (alkyl ketene dimer),
ASA (alkenyl succinic anhydride, and
rosin size.

17. The superhydrophobic coating according to claim 14, wherein the nanocellulose is hydrophobised by using at least one modifier, wherein the modifier comprises a fluorosilan.

18. The superhydrophobic coating according to claim 14, wherein the coating is a thin film.

19. The superhydrophobic coating according to claim 14, wherein the nanocellulose particles comprise spray-died nanocellulose particles.

20. The superhydrophobic coating according to claim 14, wherein the nanocellulose particles comprise refined nanocellulose aerogel particles.

21. The superhydrophobic coating according to claim 14, wherein the coating comprises a cured mixture of coating powder and nanocellulose particles.

22. The superhydrophobic coating according to claim 14, wherein the coating comprises a mixture of coating powder and hydrophobized nanocellulose particles.

23. A hydrophobic coating, wherein at least part of the coating is manufactured according to the method of claim 1.

24. A method of making liquid marbles, comprising entirely covering a liquid drop by a layer of hydrophobic particles comprising nanocellulose.
